(19) United States
(12) Patent Application Publication
(10) Pub. No.: US 2025/0103876 A1
(43) Pub. Date: Mar. 27, 2025

(54) ENSEMBLE OF REGULARIZED LOW RANK ADAPTERS FOR CALIBRATED LARGE LANGUAGE MODEL FINE-TUNING

(71) Applicant: Robert Bosch GmbH, Stuttgart (DE)

(72) Inventors: Xi Wang, Amherst, MA (US); Maja Rudolph, Madison, WI (US)

(21) Appl. No.: 18/471,802

(22) Filed: Sep. 21, 2023

(51) Int. Cl. G06N 3/08; G06N 3/0455

(52) U.S. Cl. CPC G06N 3/08; G06N 3/0455

(57) ABSTRACT

Fine-tuning a base large language model (LLM) is provided. A fine tuning of a base LLM having pre-trained model weights is performed using a plurality of LoRA components each defining a trainable low-rank matrix, such that the low-rank matrices are trained to perform the fine tuning while the pre-trained model weights remain fixed. An ensemble is constructed using the plurality of LoRA components. One or more regularization techniques are performed to the LoRA components to counter overconfidence in the ensemble of LoRA components. The ensemble of LoRA components, as regularized, are utilized as a fine-tuned model of the base LLM.

### TECHNICAL FIELD

Aspects of the disclosure relate to ensemble of regularized low-rank adapter (LoRA) for calibrated large language model (LLM) fine-tuning.

### BACKGROUND

LLMs are transformer-based architectures for modeling text, and have demonstrated state-of-art performance in many natural language processing tasks. LLMs are trained on very large text corpora to do one-step-ahead prediction. Iterative execution of this one-step-ahead prediction can yield plausible text. To achieve domain-specific performance improvements, LLMs can be fine-tuned on proprietary or specialized datasets. Fine-tuning LLMs is relevant to a large number of language tasks, including chat bots, virtual assistants, question answering systems, automatic editing services and more.

Ensemble methods are ways to combine the predictions of multiple methods into a better (more accurate or better calibrated) predictions.

Stochastic Gradient Langevin Dynamics (SGLD) is a gradient-based method for posterior sampling. After taking sufficient gradient steps of the SGLD objective, future gradient steps can be seen as samples from the model posterior. These posterior samples can be used to make predictions that take modeling uncertainty into account: Each posterior sample corresponds to a variation of the same model and can be used to make a prediction. These predictions are then averaged. For this reason, fine tuning with SGLD can also be interpreted as an ensemble method.

### SUMMARY

In one or more illustrative examples, a method for fine tuning a base LLM includes performing fine tuning of a base LLM having pre-trained model weights using a plurality of LoRA components each defining a trainable low-rank matrix, such that the low-rank matrices are trained to perform the fine tuning while the pre-trained model weights remain fixed; constructing an ensemble using the plurality of LoRA components; performing one or more regularization techniques to the LoRA components to counter overconfidence in the ensemble of LoRA components; and utilizing the ensemble of LoRA components, as regularized, as a fine-tuned model of the base LLM.

In one or more illustrative examples, a system fine tuning a base LLM includes one or more computing devices programmed to perform fine tuning of a base LLM having pre-trained model weights using a plurality of LoRA components each defining a trainable low-rank matrix, such that the low-rank matrices are trained to perform the fine tuning while the pre-trained model weights remain fixed; construct an ensemble using the plurality of LoRA components; perform one or more regularization techniques to the LoRA components to counter overconfidence in the ensemble of LoRA components; and utilize the ensemble of LoRA components, as regularized, as a fine-tuned model of the base LLM.

In one or more illustrative examples, a non-transitory computer-readable medium includes instructions for fine tuning a base LLM that, when executed by one or more computing devices, cause the one or more computing devices to perform operations including to perform fine tuning of a base LLM having pre-trained model weights using a plurality of LoRA components each defining a trainable low-rank matrix, such that the low-rank matrices are trained to perform the fine tuning while the pre-trained model weights remain fixed; construct an ensemble using the plurality of LoRA components; perform one or more regularization techniques to the LoRA components to counter overconfidence in the ensemble of LoRA components; and utilize the ensemble of LORA components, as regularized, as a fine-tuned model of the base LLM.

### BRIEF DESCRIPTION OF THE DRAWINGS

FIG. 1 illustrates an example of a fine-tuning of a multiple-choice question/answer (QA) problem;

FIG. 2 illustrates an example of accuracy versus expected calibration error for various methods discussed herein;

FIG. 3A illustrates an example predictive performance of various approaches;

FIG. 3B illustrates an example predictive performance of various approaches;

FIG. 4 illustrates an example of fine-tuning over the final linear layer and its ensemble, illustrating performance less than single or ensembles LoRA;

FIG. 5A illustrates an example of OOD performance of CQA vs MMLU;

FIG. 5B illustrates an example of OOD performance of MMLU SS vs MMLU others;

FIG. 5C illustrates an example of OOD performance of MMLU Stem vs MMLU others;

FIG. 6 illustrates an example of increasing the number of ensembles (M) aiding in accuracy but not overconfidence on a small dataset;

FIG. 7 illustrates an example of decoupling of the source of randomness in ensembling;

FIG. 8 illustrates an example process for performing an ensemble approach to fine-tuning of LLMs using LoRA; and

FIG. 9 illustrates an example of a computing device for performing aspects of an ensemble approach to fine-tuning of LLMs using LoRA.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Modern deep learning models may demonstrate poor uncertainty quantification ability. Such models often show overconfidence and badly calibrated and unreliable prediction results on data unseen during training time. To alleviate these issues, one approach is to use an ensemble of models instead of a point-estimation model when making predictions. The ensemble of models can be acquired through deep ensemble, which trains several randomly initialized models independently or through Bayesian inference, which uses approximate inference methods such as variational inference or SGLD, to get a distribution over model weights. However, these methods can be computationally expensive and may not effectively resolve the overconfidence issue. Moreover, deep ensemble may only partially mitigate overconfidence in small datasets.

Aspects of the disclosure relate to improving the uncertainty quantification ability of fine-tuned deep learning models. This is discussed in the context of LLM fine-tuning but is applicable to other types of models.

The disclosure proposes an ensemble approach using LoRA-a parameter efficient fine-tuning (PEFT) technique. A LoRA deep ensemble may make predictions by averaging the output of several independently trained LoRA adapters. LoRA's random initialization allows for model diversity, while its low-rank property minimizes storage and computational costs. This provides better predictive performance but may still not fully resolve overconfidence issues, especially when the training set is small. An example LoRA fine-tuning may be performed using an LLM, such as Llama-13b in an example, on several commonsense reasoning tasks. It can be seen that, under the standard configuration of AdamW from PyTorch, the fine-tuned model demonstrates severe overconfidence.

Moreover, by further incorporating regularization techniques together with the ensemble, both accurate and well-calibrated predictions can be achieved. Based on the observation that the pre-trained model is usually well-calibrated, regularization techniques may be considered to force the model to stay close to the pre-trained model during fine-tuning. In particular, three types of regularization are considered: weight space regularization via very large weight decay, output space regularization via Kullback-Leibler (KL) regularization and implicit regularization through early stopping. It can be shown that these regularization approaches can in general lead to improved calibration and uncertainty quantification. While regularization methods could potentially cause degradation in accuracy, the regularization may be combined with LoRA ensembling to achieve models with both accuracy and calibration. This overall technique may be referred to as an efficient ensemble of regularized models (EERM).

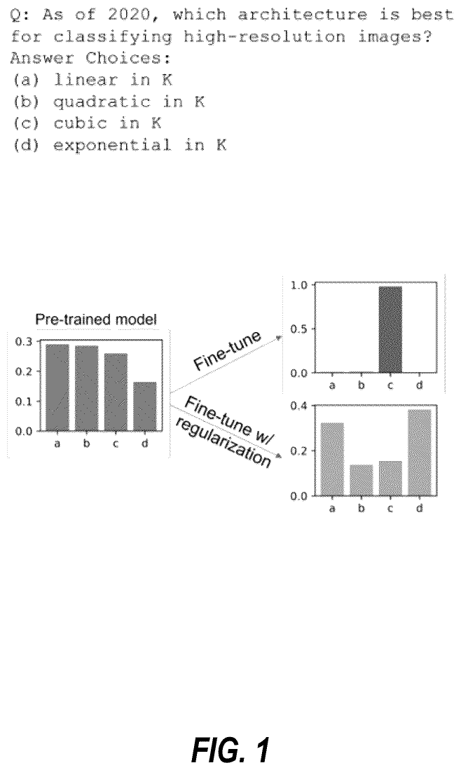

FIG. 1 illustrates an example 100 of a fine-tuning of a multiple-choice QA problem. To adapt a pre-trained LLM to downstream applications or data, it is very common to fine-tune the model. Fine-tuning is a process whereby, instead of beginning with random weights, a model that has already been trained for one given task is used as a starting point to tunes or tweaks a new model to make it perform a second similar task. A fine-tuning for the multiple-choice QA may be performed, as an example. Given a problem where all options are non-sense, a fine-tuned model outputs high confidence prediction, potentially misleading downstream decision making.

Standard fine-tuning of LLMs requires updating the whole model at each iteration, which involves potentially several billions of parameters. A recent line of work, PEFT, aims at performing fine-tuning with a small amount of parameters. One way to achieve this is through LoRA, which introduces trainable low-rank matrices ΔW=BA, B∈ [symbol] , A∈ [symbol] to the pre-trained model weights W∈ [symbol] where r is a hyper-parameter that denotes the rank of the adapter. The LoRA freezes the pretrained model weights and injects trainable rank decomposition matrices into layers of the transformer architecture, greatly reducing the number of trainable parameters for downstream tasks. The optimization happens on the low-rank matrices of ΔW instead of over the pre-trained model weights of W.

In this setting, the optimization objective can be written as:

$${min}_{Δ W} {\sum }_{n = 1}^{N} - log p ( {y}_{n} \vert {X}_{n} ; W + Δ W ) \qquad ( 1 )$$

Note that A∈ [symbol] and B∈ [symbol] . During training, A is randomly initialized with standard Gaussian, and B is initialized as zero. In LoRA, the random initialization in A can lead to a diverse set of ΔW when the optimization finishes. LoRA allows the performance of deep ensemble during the LLM fine-tuning, as an ensemble can be constructed via:

$$\overline{p} ( y \vert X ) = \frac{1}{M} {\sum }_{m = 1}^{M} p ( y \vert X , W + Δ {W}_{m} ) \qquad ( 2 )$$

where {ΔW₁, . . . , ΔW_{M}} is a collection of adapter acquired using different (random) initializations.

After fine-tuning, the LoRA can be saved and loaded efficiently as it only takes a very small amount of memory, relatively speaking. This also enables one to efficiently perform ensembling during prediction. Even if deep ensemble is performed with full parameter fine-tuning, it may not be practical to save multiple copies of the full model and load them at inference time. With an ensemble of LoRA, a large base model may be loaded only once, and the ensembling may be performed by only loading the different LoRA components, which are much smaller and more efficient.

Similar to deep learning models trained from scratch, fine-tuned LLMs may easily overfit to the training data and demonstrate overconfidence prediction on test data. Such overconfidence could cause the predictive distribution to be unreliable, as it will be poorly calibrated and may fail to represent uncertainty. This may be concerning in important scenarios such as medical diagnosing, finance, or decision-making. As shown in the example of FIG. 1, the results of a QA of a problem with no correct answer shows a distribution of answers, while the fine-tuned model instead shows overconfidence in predicting mainly one of the incorrect answers.

Regarding this ensemble of regularized LoRA, the ensembled predictive distribution of Eq. (2) usually shows better calibration than a single base model, in that the sharpness in each overconfidence component gets averaged out through ensembling. However, each base model still shows overconfidence, which could lead to bad calibration. Therefore, combining regularization techniques together with LoRA can play a more critical role than ensembling when fighting overconfidence, especially when the training data is small or on out-of-distribution samples. As shown in the example of FIG. 1, while the fine-tuned model shows overconfidence in predicting one of the incorrect answers, the regularized fine-tuned model retains a distribution of answers.

To be more specific, the following three types of regularization technique are considered: weight space regularization, output space regularization, and implicit regularization with early stopping.

For instance, weight space regularization via very large weight decay may be used as a regularization technique. Weight space regularization is perhaps the most straight-forward approach for regularizing the finetuned model. In particular, consider using very large decoupled weight decay. At the tₜₕ time step, decoupled weight decay performs optimization as follows:

$${W}_{t} ← {W}_{t - 1} - γ ( {g}_{t - 1} - λ {W}_{t - 1} ) \qquad ( 3 )$$

where:
γ denotes the step size,
gₜ₋₁ denotes the normalized gradient acquired from standard Adam with no regularization, and
λ adjusts the strength of regularization.

Although weight decay is a standard regularization technique, a setup with a λ of 1e-2 (e.g., the default setting from PyTorch's AdamW) barely helps resolve the overconfidence issue. Instead, a large value of λ ranging from 1e1 to 1e3 may be adopted. In addition, it can be seen that the regularization is preferable to be weight decay as opposed to, for example, L2 regularization.

In another example, output space regularization via KL regularization may be used as a regularization technique. In LLM fine-tuning, a KL regularization may be included to ensure the output distribution of the fine-tuned model is close to that of the pre-trained model. In the discussed setting, the following KL regularization objective may be considered as follows:

$$β {D}_{KL} ( p ( y \vert X , W + Δ W ) \vert \vert p ( y \vert X , W ) ) \qquad ( 4 )$$

which is added to Eq. (1) during optimization. The value of β controls the strength of the regularization.

In another example, regularization with early stopping may be considered. Early stopping halts the optimization when certain criteria are met such that the model is not “over-optimized.” In particular, early stopping is considered after certain epochs ranging from 1 to 3. The fewer epochs used, the stronger the regularization is.

Ensembling may be evaluated over LoRA and its regularized version. For multiple-choice QA problems, given a problem description (denoted as X) and its label set y=a, b, c, . . . , the problem may be encoded as follows:
Q: QUESTION TEXT
Answer choices:
(a) OPTION 1
(b) OPTION 2
. . .
A: (
   This string may be fed into the LLM to acquire conditional probability for the token after the left parentheses “(”. The logits corresponding to the options in the label set may be extracted, re-normalized, and used as log p(y|X;W), where W denotes a parameter of the LLM. The scope in the multiple-choice QA problem is limited in that it resembles a classic classification setting where calibration and uncertainty are well-defined concepts. For open-ended generation tasks, the definition of calibration and uncertainty are still under active research.

To be more specific, six popular multiple-choice QA datasets are used for evaluation: CommonsenseQA (CQA), OpenBook (OBQA), social sciences (MMLU SS) and STEM (MMLU STEM) subset from MMLU, ARC-easy (ARCE) and ARC-challenge (ARCC) from AI2 Reasoning Challenge. Questions in CQA have five options while the others all have four options. Details for the training and test set of each task in Table 1. The few shot results are shown in Table 2, which shoes shows that the pre-trained model few shot models show better-than-random-guess performance in all tasks and good in calibration.

TABLE 1
Summary of datasets.

| Task | Size of training set | Size of test set |
|---|---|---|
| cqa | 8741 | 1221 |
| obqa | 4957 | 500 |
| arce | 2249 | 2375 |
| arcc | 1119 | 1172 |
| mmlu ss. | 397 | 3077 |
| mmlu stem | 411 | 3018 |

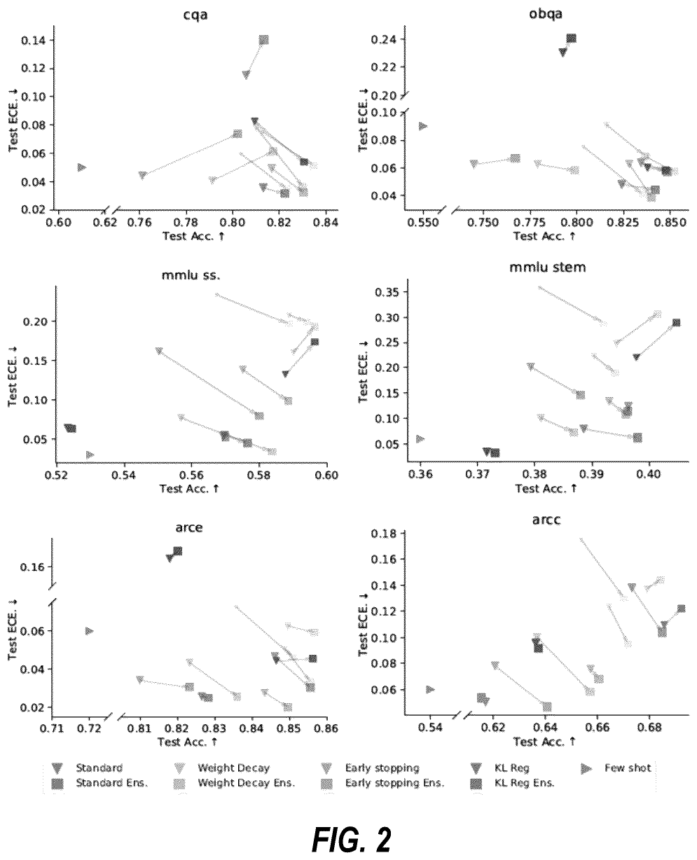

FIG. 2 illustrates an example of accuracy versus expected calibration error for various methods discussed herein. The different points represent the value of a metric averaged at different epochs and random seeds. Specifically, test results are shown for Commonsense QA, Openbook QA, MMLU Social Sciences, MMLU STEM, ARCE, and ARCC. The X-Axis of each graph shows accuracy, while the Y-Axis of each graph shows ECE. For each test, results are shown for standard fine-tuning, standard ensemble fine-tuning, weight decay fine-tuning, weight decay ensemble fine-tuning, early stopping fine-tuning, early stopping ensemble fine-tuning, KL regularization, and KL regularization ensemble. Few shot results are also shown for comparison, as few shot results are usually worse in terms of accuracy but tend to be better calibrated. It can be seen that the ensembled fine-tuning consistently improves accuracy across all methods.

Table 1 shows a summary of datasets. For CQA, the validation set that is used is provided as test set. For MMLU, the development and validation set is combined as the training set and the original test split is used as the test set. For the rest of the datasets, a default training and test split is used. For Table 2, all results are based on 10 random seeds, and model is llama 13b.

TABLE 2
Few shot results on tasks

| | Acc. | | | NLL. | | | ECE. | | |
|---|---|---|---|---|---|---|---|---|---|
| | 0 shot | 1 shot | 3 shots | 0 shot | 1 shot | 3 shots | 0 shot | 1 shot | 3 shots |
| cqa | 0.47 | 0.55 | 0.61 | 1.35 | 1.20 | 1.07 | 0.11 | 0.07 | 0.07 |
| obqa | 0.50 | 0.50 | 0.55 | 1.21 | 1.17 | 1.09 | 0.13 | 0.08 | 0.08 |
| arce | 0.70 | 0.68 | 0.72 | 0.92 | 0.83 | 0.74 | 0.19 | 0.05 | 0.06 |
| arcc | 0.53 | 0.52 | 0.54 | 1.15 | 1.17 | 1.12 | 0.10 | 0.06 | 0.06 |
| mmlu ss. | 0.49 | 0.51 | 0.53 | 1.18 | 1.14 | 1.10 | 0.06 | 0.04 | 0.03 |
| mmlu stem | 0.34 | 0.34 | 0.36 | 1.33 | 1.35 | 1.32 | 0.04 | 0.07 | 0.05 |

For predictive performance on in-distribution data, for all 6 tasks, the accuracy (Acc.), negative log-likelihood (NLL), and expected calibration error (ECE) are measured on the test set to evaluate the predictive performance of a model.

Regarding out-of-distribution (OOD) behavior, in order for safe deployment in real-world applications, it is also important to study the behavior of a model when the test data comes from out-of-distribution (OOD) domain. In particular, models fine-tuned on CQA are tested with the test set from MMLU as OOD and models fine-tuned on a subset of MMLU are tested with test samples from other MMLU subcategories. Then, the Acc., NLL., ECE., is computed and additionally, the OOD detection performance is measured by AUROC on the OOD test samples.

Next, empirical results are presented. AdamW is used for all experiments. For the standard LoRA fine-tuning, a step size of 5e-5 is used with weight decay of 0.01. A batch size of 32 is used for CQA, 16 for OBQA, ARCC, and ARCE, and eight for MMLU SS and STEM.

To start with, ensemble of LoRA is comparted under standard AdamW configuration (i.e. with weight decay coefficient of 1e-2) with two baseline ensembling methods for fine-tuning LLM: Ensemble of last-layer fine-tuning and Monte Carlo (MC) dropout. For all ensemble methods, predictions are made with five ensemble components.

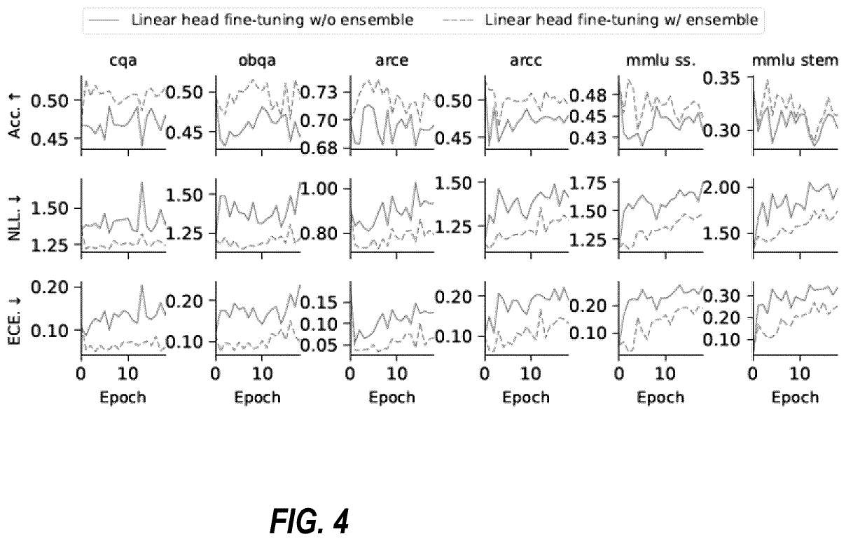

Last-layer fine-tuning refers to fine-tuning only the rows in the final linear head that correspond to the token for the options. The linear head is fine-tuned multiple times starting from the pre-trained weights under different random seeds to construct an ensemble. The results are presented in FIG. 4. It can be seen that, although ensemble of last-layer fine-tuning does show improvement upon its single model variant, it overall shows performance much worse than Ensemble of LoRA. This may be caused by the poor performance of the base method. Fine-tuning only the last-layer may not be expressive enough to adapt the model for downstream tasks.

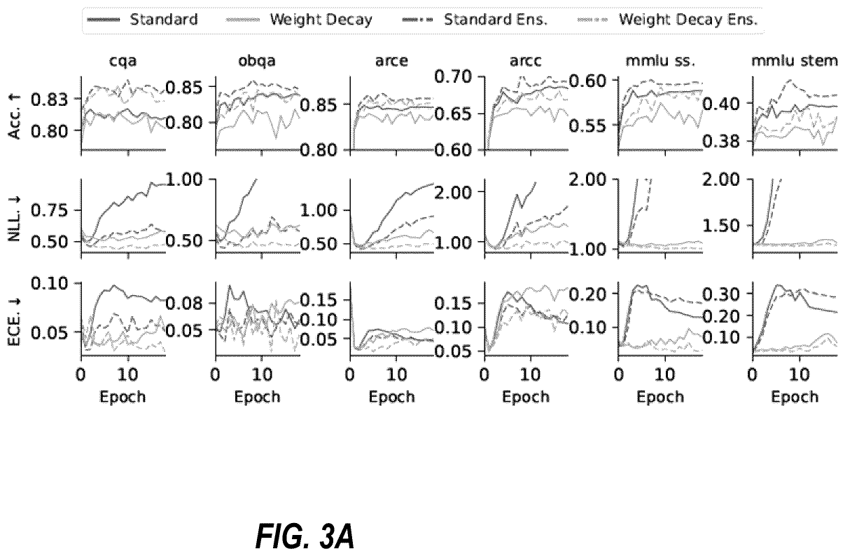

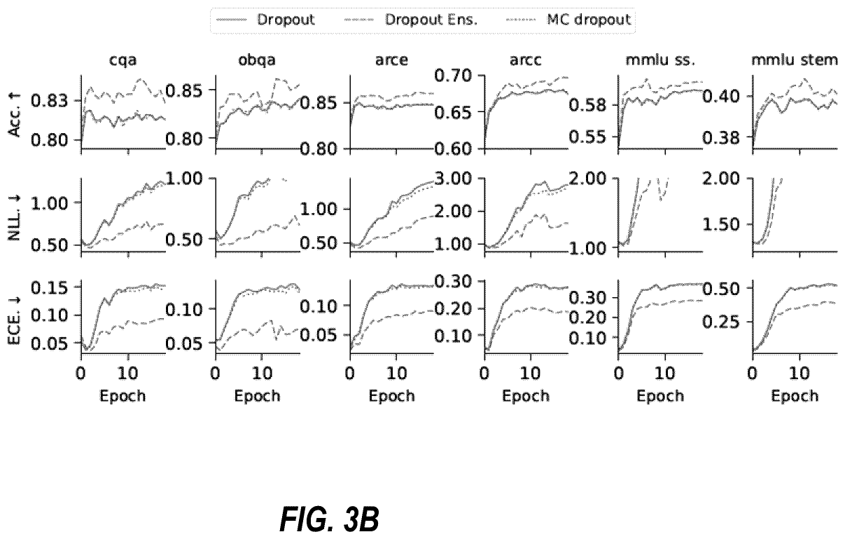

Additionally, MC dropout is considered. When dropout is employed at training time, it can be keep on at test time and multiple forward passes can be performed with nodes randomly shut down to construct an ensemble. Dropout to LoRA fine-tuning may be combined by adding dropout on the input of the LoRA adapter BA Dropout (x). The results are presented in FIG. 3B, where it can be seen that MC dropout shows only marginal improvement upon the performance of a single model, outperformed by combining training time dropout and Ensemble of LoRA.

Next, it is demonstrated the importance of regularization when performing Ensemble of LoRA. In FIG. 3A, it is shown that when fine-tuning on small datasets (e.g., MMLU), the NLL of standard Ensemble of LoRA still blows up even with ensembling. Therefore, further regularization techniques can be incorporated on the top of ensembling to alleviate overconfidence.

The trace of different metrics under weight decay regularization is presented in FIG. 3A. It can be seen that ensemble of weight decay regularized LoRA, despite showing slightly worse accuracy, shows significantly better calibration error and NLL compared with the un-regularized version. The importance of regularization is more obvious in OOD setting.

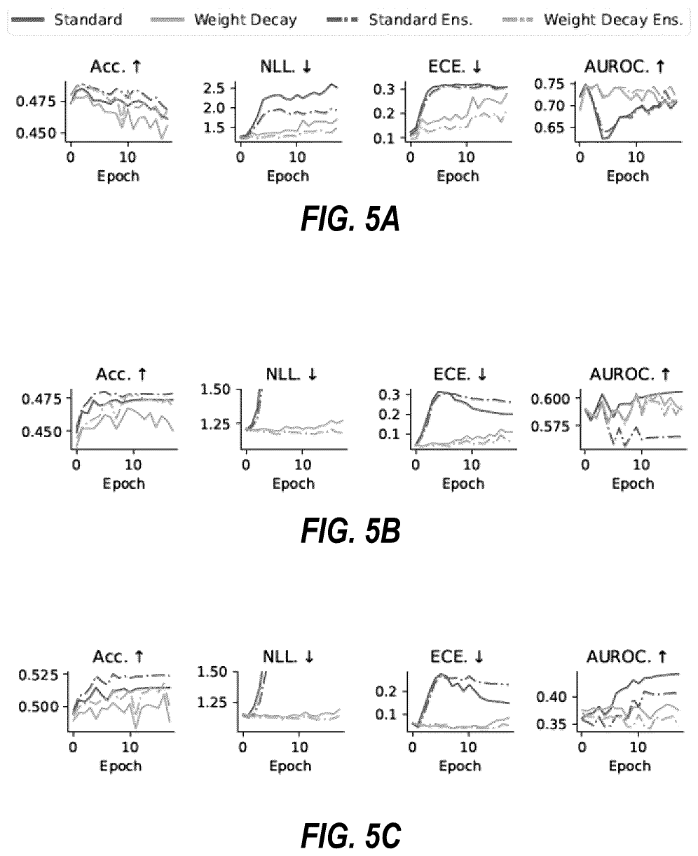

FIG. 5A illustrates an example of OOD performance of CQA vs MMLU. FIG. 5B illustrates an example of OOD performance of MMLU SS vs MMLU others. FIG. 5C illustrates an example of OOD performance of MMLU Stem vs MMLU others. In FIG. 5A, when the model is fine-tuned on CQA, catastrophic forgetting occurs as the accuracy on MMLU starts dropping when fine-tuning proceeds. Without regularization, the model starts to make wrong but overconfident predictions, causing severe increments in expected calibration error whereas regularized ensemble shows much lower NLL and ECE.

In addition to weight decay, KL regularization and early stopping are considered. These are presented in the results in FIG. 2. It can be observed that the best calibration error is always achieved by regularization plus ensemble, suggesting that Ensemble of regularized LoRA is critical for building accurate and calibrated fine-tuned models.

Next, a more detailed understanding of the LoRA ensemble is provided.

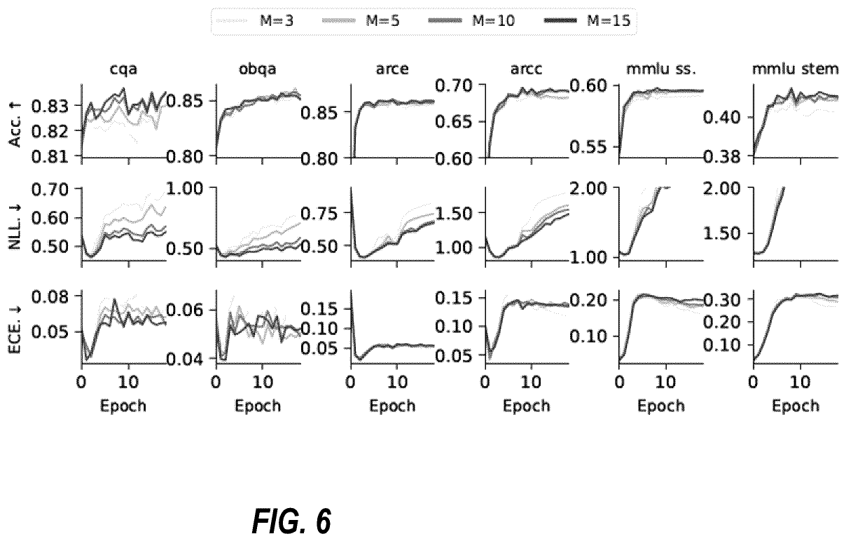

Regarding the number of ensemble components, to start with, the effects of ensemble components are studied. The results are shown in FIG. 6. It can be noticed that increasing the number of components improves all metrics. However, using an extra number of ensemble components does not resolve the overconfidence problem, which again emphasizes the importance of introducing regularization into fine-tuning.

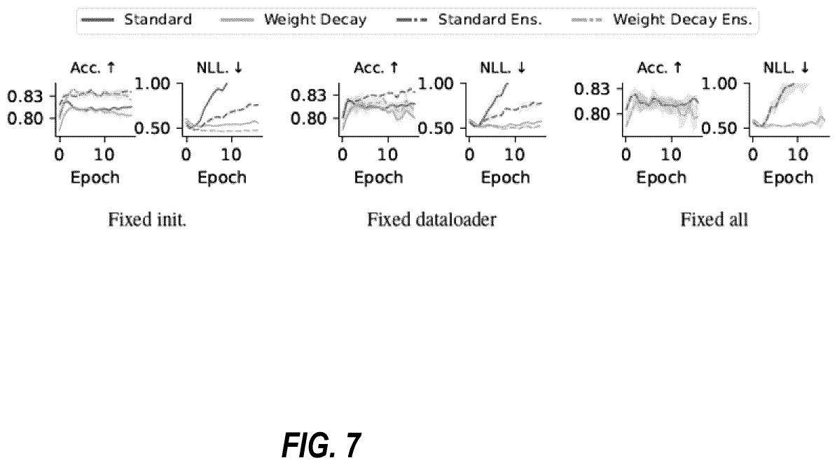

Regarding the source of randomness, the source of randomness in LoRA ensemble is studied. It is often believed that random initialization contributes mostly to the diversity of ensemble. However, it is unclear whether it is the case for Ensemble of LoRA. To understand which source of randomness plays a more critical role, experiments are conducted on CQA where the initialization is fixed, the dataloader is fixed, and both are fixed. The results are presented in FIG. 7. Unlike the full model ensemble, the randomness from dataset shuffling (i.e. SGD noise) contributes more to the ensemble performance in LoRA fine-tuning. However, it is worth pointing out that one should still incorporate both sources of randomness in practice.

Effect of regularization on ensemble diversity is next discussed. It can be noticed that regularization does affect ensemble diversity. In FIG. 2, it can be seen that a high strength of KL regularization and early stopping could cause ensembling to lose its effect. This is not surprising in that KL regularization directly forces all ensemble components to make predictions similar to the pre-trained model while early stopping prevents different ensemble components from performing further random walk under SGD. Weight decay, however, suffers the least from this problem, which is likely because of the complicated relationship between the weight space of NN and the output space diversity.

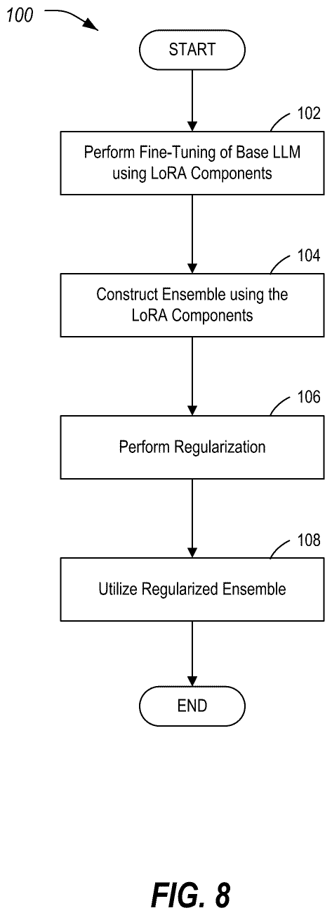

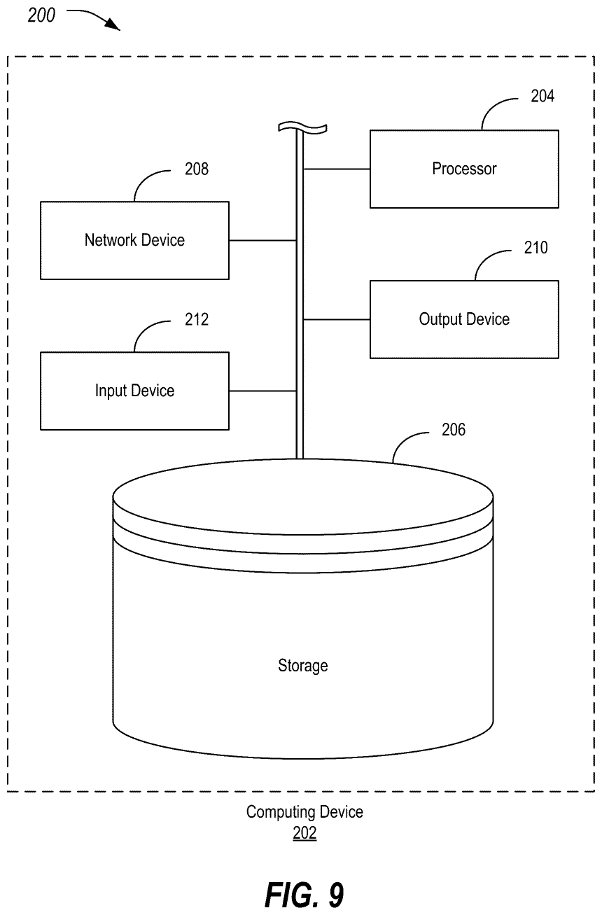

FIG. 8 illustrates an example process 100 for performing an ensemble approach to fine-tuning of LLMs using LoRA. In an example, the process 100 may be performed using a base LLM and one or more of the techniques discussed in detail above. The process 100 may be performed using one or more of the devices discussed in FIG. 9.

At operation 102, fine tuning of a base LLM is performed. The base LLM may have pre-trained model weights, and the fine tuning may be performed using a plurality of LoRA components each defining a trainable low-rank matrix, such that the low-rank matrices are trained to perform the fine tuning while the pre-trained model weights remain fixed. In an example, each LoRA component includes a matrix A configured as a projection that maps origin features of the base large language model into a lower dimension, in combination with the low-rank matrix B that performs learning for the fine tuning, wherein the one or more regularization techniques are performed on matrix B. During training, the A matrix of the LoRAs is randomly initialized with standard Gaussian, and B is initialized as zero. This random initialization in A can lead to a diverse set of ΔW when the optimization finishes.

At operation 104, an ensemble is constructed using the plurality of LoRA components. An example illustrating the ensembling is shown in Eq. 2. In an example, the ensemble is loaded by loading the base large language model once, and loading each of the ensemble of LoRA components in combination with the same the base large language model.

At operation 106, one or more regularization techniques are performed to the LoRA components to counter overconfidence in the ensemble of LoRA components. In an example, the one or more regularization techniques includes weight decay. Weight decay is discussed, for example, with respect to Eq. 3. As explained herein, weight decay can be used combined with ensembling for boosting predictive performance. In another example, the one or more regularization techniques includes output space regularization via KL regularization. KL regularization is discussed, for example, with respect to Eq. 4. In yet another example, the one or more regularization techniques includes implicit regularization through early stopping.

At operation 108, the ensemble of LoRA components, as regularized, is utilized as a fine-tuned model of the base large language model. In an example, the fine tuning task is adapting the pre-trained LLM to downstream applications or data, and the utilization of the fine-tined model is responding to prompts for those applications or data. In one non-limiting example, the fine tuning may be performed to teach domain-specific information to the model, and the utilization may include QA using the domain-specific information. After operation 108, the process 100 ends.

FIG. 9 illustrates an example 200 of a computing device 202 for implementing aspects of an ensemble approach to fine-tuning of LLMs using LoRA. Referring to FIG. 9, and with reference to FIGS. 1-8, the processes discussed herein may be performed by such computing devices 202. As shown, the computing device 202 includes a processor 204 that is operatively connected to a storage 206, a network device 208, an output device 210, and an input device 212. It should be noted that this is merely an example, and computing devices 202 with more, fewer, or different components may be used.

The processor 204 may include one or more integrated circuits that implement the functionality of a central processing unit (CPU) and/or graphics processing unit (GPU). In some examples, the processors 204 are a system on a chip (SoC) that integrates the functionality of the CPU and GPU. The SoC may optionally include other components such as, for example, the storage 206 and the network device 208 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 204 executes stored program instructions that are retrieved from the storage 206. The stored program instructions, accordingly, include software that controls the operation of the processors 204 to perform the operations described herein. The storage 206 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system.

The GPU may include hardware and software for display of at least two-dimensional (2D) and optionally three-dimensional (3D) graphics to the output device 210. The output device 210 may include a graphical or visual display device, such as an electronic display screen, projector, printer, or any other suitable device that reproduces a graphical display. As another example, the output device 210 may include an audio device, such as a loudspeaker or headphone. As yet a further example, the output device 210 may include a tactile device, such as a mechanically raiseable device that may, in an example, be configured to display braille or another physical output that may be touched to provide information to a user.

The input device 212 may include any of various devices that enable the computing device 202 to receive control input from users. Examples of suitable input devices that receive human interface inputs may include keyboards, mice, trackballs, touchscreens, voice input devices, graphics tablets, and the like.

The network devices 208 may each include any of various devices send and/or receive data from external devices over networks. Examples of suitable network devices 208 include an Ethernet interface, a Wi-Fi transceiver, a cellular transceiver, or a BLUETOOTH or BLE transceiver, UWB transceiver, or other network adapter or peripheral interconnection device that receives data from another computer or external data storage device, which may be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for fine tuning a base large language model (LLM), comprising:
performing fine tuning of a base LLM having pre-trained model weights using a plurality of LoRA components each defining a trainable low-rank matrix, such that the low-rank matrices are trained to perform the fine tuning while the pre-trained model weights remain fixed;
constructing an ensemble using the plurality of LoRA components;
performing one or more regularization techniques to the LoRA components to counter overconfidence in the ensemble of LoRA components; and
utilizing the ensemble of LoRA components, as regularized, as a fine-tuned model of the base LLM.

2. The method of claim 1, wherein each LoRA component includes a matrix A configured as a projection that maps origin features of the base LLM into a lower dimension, in combination with the low-rank matrix B that performs learning for the fine tuning, wherein the one or more regularization techniques are performed on matrix B, or on matrix A, or on matrices A and B.

3. The method of claim 1, wherein the matrix A is randomly initialized with standard Gaussian, and the matrix B is initialized as zero.

4. The method of claim 1, wherein the one or more regularization techniques includes weight decay.

5. The method of claim 1, wherein the one or more regularization techniques includes output space regularization via Kullback-Leibler (KL) regularization.

6. The method of claim 1, wherein the one or more regularization techniques includes implicit regularization through early stopping.

7. The method of claim 1, wherein the ensemble is loaded by loading the base LLM once, and loading each of the ensemble of LoRA components in combination with the same the base LLM.

8. The method of claim 1, wherein the fine tuning includes learning domain-specific information into the base LLM, and the utilizing includes question/answer (QA) using the domain-specific information.

9. A system for fine tuning a base large language model (LLM), comprising:
one or more computing devices programmed to:
perform fine tuning of a base LLM having pre-trained model weights using a plurality of LoRA components each defining a trainable low-rank matrix, such that the low-rank matrices are trained to perform the fine tuning while the pre-trained model weights remain fixed;
construct an ensemble using the plurality of LoRA components;
perform one or more regularization techniques to the LoRA components to counter overconfidence in the ensemble of LoRA components; and
utilize the ensemble of LoRA components, as regularized, as a fine-tuned model of the base LLM.

10. The system of claim 9, wherein each LoRA component includes a matrix A configured as a projection that maps origin features of the base LLM into a lower dimension, in combination with the low-rank matrix B that performs learning for the fine tuning, wherein the one or more regularization techniques are performed on matrix B, or on matrix A, or on matrices A and B.

11. The system of claim 9, wherein the matrix A is randomly initialized with standard Gaussian, and the matrix B is initialized as zero.

12. The system of claim 9, wherein the one or more regularization techniques includes weight decay.

13. The system of claim 9, wherein the one or more regularization techniques includes output space regularization via Kullback-Leibler (KL) regularization.

14. The system of claim 9, wherein the one or more regularization techniques includes implicit regularization through early stopping.

15. The system of claim 9, wherein the one or more computing devices are programmed to load the ensemble by loading the base LLM once, and load each of the ensemble of LoRA components in combination with the same the base LLM.

16. The system of claim 9, wherein the fine tuning includes to learn domain-specific information into the base LLM, and the utilization includes question/answer (QA) using the domain-specific information.

17. A non-transitory computer-readable medium comprising instructions for fine tuning a base large language model (LLM) that, when executed by one or more computing devices, cause the one or more computing devices to perform operations including to:
perform fine tuning of a base LLM having pre-trained model weights using a plurality of LoRA components each defining a trainable low-rank matrix, such that the low-rank matrices are trained to perform the fine tuning while the pre-trained model weights remain fixed;
construct an ensemble using the plurality of LoRA components;
perform one or more regularization techniques to the LoRA components to counter overconfidence in the ensemble of LoRA components; and
utilize the ensemble of LoRA components, as regularized, as a fine-tuned model of the base LLM.

18. The medium of claim 17, wherein each LoRA component includes a matrix A configured as a projection that maps origin features of the base LLM into a lower dimension, in combination with the low-rank matrix B that performs learning for the fine tuning, wherein the one or more regularization techniques are performed on matrix B, or on matrix A, or on matrices A and B.

19. The medium of claim 18, wherein the matrix A is randomly initialized with standard Gaussian, and the matrix B is initialized as zero.

20. The medium of claim 18, wherein the one or more regularization techniques includes weight decay.

21. The medium of claim 18, wherein the one or more regularization techniques includes output space regularization via Kullback-Leibler (KL) regularization.

22. The medium of claim 18, wherein the one or more regularization techniques includes implicit regularization through early stopping.

23. The medium of claim 18, further comprising instructions that, when executed by the one or more computing devices, cause the one or more computing devices to perform operations including to load the ensemble by loading the base LLM once, and load each of the ensemble of LoRA components in combination with the same the base LLM.
